(19) United States
(12) Patent Application Publication
(10) Pub. No.: US 2005/0038946 A1
(43) Pub. Date: Feb. 17, 2005

(54) System and method using a high speed interface in a system having co-processors

(75) Inventor: Bruce Stephen Borden, Los Altos, CA (US)

Correspondence Address: STERNE, KESSLER, GOLDSTEIN & FOX PLLC, 1100 NEW YORK AVENUE, N.W., WASHINGTON, DC, 20005, US

(73) Assignee: Tadpole Computer, Inc.

(21) Appl. No.: 10/915,375

(22) Filed: Aug. 11, 2004

Related U.S. Application Data
(60) Provisional application No. 60/494,682, filed on Aug. 12, 2003.

(51) Int. Cl. G06F 13/14

(52) U.S. Cl. 710/310

(57) ABSTRACT

A system and method utilize a high-speed bus interface with a direct access memory (DMA) engine in between high-performance co-processors with one or more CPUs connected into a computer system with one or more host CPUs. In one example, the DMA engine allows for all of the processors to run efficiently and asynchronously, while facilitating communication between offload processors and host processors. In one example, the DMA engine utilizes all of the available bus interface bandwidth with very little overhead and reduces interrupts to a minimum. In one example, the DMA interface system accepts commands from both sides and insures that all commands are completed with long commands interwoven with short commands for low latency and high bandwidth.

### CROSS-REFERENCE TO RELATED APPLICATIONS

This application claims priority under 35 U.S.C. §119(e) to U.S. Provisional Application No. 60/494,682, filed Aug. 12, 2003, entitled “DMA Engine for High-Speed Co-Processor Interface System,” which is incorporated herein by reference in its entirety.

### BACKGROUND OF THE INVENTION

1. Field of the Invention

The present invention relates generally to high speed interface systems in co-processor environments.

2. Related Art

Many high-performance devices have direct memory access (DMA) controllers in them. The DMA controllers have logic that allow blocks of data to move to/from the device and host memory across a bus interface, such as a peripheral component interconnect (PCI) bus interface. Some of these high performance devices include two or more computers having one or more processors in each, where the DMA controller is used to move blocks of data between the processors via their respective associated memories and bus interfaces.

### SUMMARY OF THE INVENTION

An embodiment of the present invention provides a system, comprising a first portion having at least a first processor, a second portion having at least a second processor, and an interface system coupled between the first processor and the second processor. Thee interface system includes a memory system. The interface system allows for writing of information from one or both of the first and second processors to the memory system without a read operation.

Another embodiment of the present invention provides an interface system in a system including at least a first portion having at least a first processor and a second portion having at least a second processor. The interface system comprises a first bus interface associated with the first processor, a second bus interface associated with the second processor, and a memory system. The interface system allows for writing of information from one or both of the first and second processors to the memory system without a read operation.

A further embodiment of the present invention provides a method comprising the steps of (a) storing information from one or more processors into a memory system at a first information flow rate, (b) determining if the memory system has reached a first threshold level, (c1) if yes in step (b), setting an information from rate to a second information flow rate, which is below the first information flow rate, (c2) if no in step (b), continue performing steps (a) and (b), and (d) if (c1) is performed, resetting an information flow rate to the first information flow rate once a second threshold level is reached for the memory system, which is below the first threshold level.

A still further embodiment of the present invention provides a method comprising the steps of (a) storing, in a first table, at least one block of information from a first processor, (b) storing, in a first register, an address associated with each respective one of the at least one block of information in the first table, (c) storing, in a second table, at least one block of information from a second processor, (d) storing, in a second register, an address associated with each respective one of the at least one block of information in the second table, and (e) transferring one or more of the at least one block of information and associated address between the first table and first register and the second table and second register.

A still further embodiment of the present invention provides a method comprising the steps of (a) transmitting information between processors in a system having at least two processors, (b) determining a characteristic about the system, (c) setting an information segment size transmitted during each transmission period based on the characteristic of the system, (d) limiting step (a) based on step (c), and (e) sending related ones of the information segments during one or more subsequent ones of the transmission periods.

In a further embodiment, the present invention provides a computer program product comprising a computer useable medium having a computer program logic recorded thereon for controlling at least one processor, the computer program logic comprising computer program code devices that perform operations similar to the devices in the above embodiment.

Further features and advantages of the invention, as well as the structure and operation of various embodiments of the invention, are described in detail below with reference to the accompanying drawings.

### BRIEF DESCRIPTION OF THE DRAWINGS/FIGURES

The invention shall be described with reference to the accompanying figures.

FIG. 1 shows a co-processor and interface system, according to one embodiment of the present invention.

FIGS. 2 and 3 show interface system portions of the system in FIG. 1, according to various embodiments of the present invention.

FIG. 4 is a flow chart depicting an information storage method, according to one embodiment of the present invention.

FIGS. 5, 6, 7, and 8 are flow charts depicting different portions of an information storage method, according to one embodiment of the present invention.

FIGS. 9 and 10 are flows charts depicting various information storage methods, according to various embodiments of the present invention.

FIG. 11 shows a portion of an interface system, according to one embodiment of the present invention.

FIGS. 12, 13, 14, and 15 are flow charts depicting various message passing methods, according to various embodiments of the present invention.

FIGS. 16 and 17 are flow charts depicting various multi-segment transfer methods, according to various embodiments of the present invention.

FIG. 18 illustrates an example computer system, in which at least a portion of the present invention can be implemented as computer-readable code.

In the drawings, like reference numbers may indicate identical, functionally similar, and/or structurally similar elements. The drawing in which an element first appears may be indicated by the left-most digit(s) in the corresponding reference number.

### DETAILED DESCRIPTION OF THE INVENTION

Introduction

One or more embodiments of the present invention provide an interface system, for example a FPGA (Field Programmable Gate Array), between a first portion having at least a first processor (e.g., a host system processor, a Symmetric Multi-Processor (SMP), host central processing unit (CPU), or the like) and a second portion having at least a second processor (e.g., an offload processor, a co-processor, a set of co-processors, or the like). The FPGA implements data memory access (DMA) in both directions (i.e., host to offload and offload to host) though use of a host bus interface (e.g., a PCI bus interface) and an offload bus interface (e.g., a HT (hypertransport interface) and a memory system.

In one example, the FPGA “streams” data. This means the FPGA performs one arbitration handshake, exchanges one address, and then many (e.g., up to approximately thousands) of data words are transferred without any extra or wasted cycles.

Overview of Interface systems

As discussed above, many high-performance devices have DMA controllers in them. Until very recently, memory has been very “expensive” inside of an FPGA or ASIC (Application Specific Integrated Circuit). That is, high-speed RAM inside a chip took many gates and was treated as a scarce resource.

Control interface systems associated with DMA controllers have typically used interlocks to prevent a host device from overrunning the DMA controller. This has been seen as being inefficient. For the PCI bus interface, this will often lead to half or more of the bus interface bandwidth lost to arbitration cycles.

Typically, when a host processor writes commands into a buffer in memory, the host device first goes into a data cache of the processor, and then gets written to memory at some time later, which depends on the type of cache on the processor. When the DMA controller goes to read the host memory, it must first arbitrate for the bus interface, which takes several bus interface clocks. Then, the DMA controller sends an address in the host memory to be read. The bus interface then goes to the host memory and fetches the data after synchronizing with the cache to insure that bus interface gets the right data. This takes several more bus interface clocks. Finally, the data is moved across the bus interface, taking a clock per “word” (e.g., 32-bit or 64-bit transfer, depending on PCI bus interface width). To read one word, assume a word is 64 bits, or 8 bytes, this will often take 8-10 bus interface clocks for the one data word. The bus interface is unusable during this time.

In contrast to these typical methods, as discussed in more detail below with reference to one or more embodiments of the present invention, a “posted write,” or a write directly to a “register” in a PCI device, can be very efficient. Once the host does the “store,” the data is automatically sent directly to the PCI interface system. This leads to a bus interface arbitration (e.g., only a few clocks), then one address cycle and one bus interface cycle for each word (64-bits) written, then the transaction ends.

Terminology

The use of “word” can mean 32-bit or 4 bytes or 64-bits or 8 bytes throughout this document, although the invention is not limited to these examples. However, the embodiments discussed below are directed to using 64-bits as a word, although such use is for illustrative purposes only, and the invention is not limited to these examples.

The use of “information,” or derivations thereof, will mean either messages, commands, words, or data (e.g., any audio, video, textual, or the like) that is transmitted between one or more processors.

The use of “processor” means one or more processors, which may be located in a processor complex, such as in a Symmetric Multi-Processor (SMP) system.

Exemplary Co-Processor System

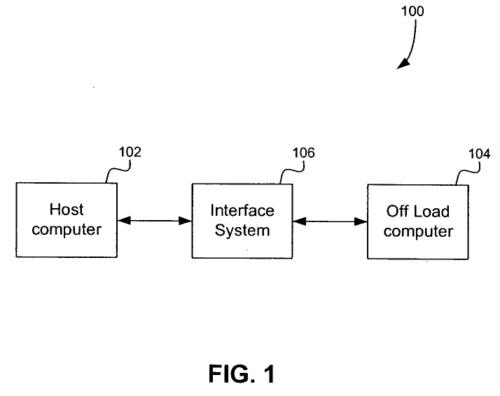

FIG. 1 shows a system 100, according to one embodiment of the present invention. System 100 comprises a first portion or computer 102 (e.g., a host portion or computer with one or more processors, hereinafter all referred to as “a processor”), a second portion or computer 104 (e.g. an off load portion or computer with one or more processors, hereinafter all referred to as “a processor”), and an interface system 106 coupled therebetween. In one example, interface system 106 functions as a DMA controller to control transferring or moving of information between processors 102 and 104. For example, as described in more detail below, interface system 105 can be an FPGA.

It is to be appreciated that, although this description is written in terms of a co-processor system, the interface and operations described are equally applicable to a co-computer system in which each computer has more than one processor or CPU (central processing unit). Both arrangements are contemplated within the scope of the present invention, as would be apparent to one of ordinary skill in the art upon reading and understanding this description.

In one example, system 100 utilizes memory-on-chip technology to allow for a more efficient DMA controller. As is described in more detail below, system 100 allows information to be transmitted directly from one or both processors 102 or 104 into interface system 106 without buffering and during one memory cycle.

In this embodiment, each processor 102 and 104 has its own respective bus (not shown) and each is running off a respective clock. Processors 102 and 104 pass information (e.g., commands, data, messages, etc.) back and forth and cooperate with each other. For example, this can be done in a networking co-processing card, in a video compression engine, an encryption engine, or any other application utilizing co-processors.

In one example, system 100 builds upon a TCP Offload Engine (TOE). A TOE basically moves a TCP/IP stack or network stack out of a host processor, for example processor 102, for efficiency. System 100 does more than this by running a full operating system out on a board (not shown). System 100 accepts connections, handles routing tables, handles error recovery, fragmentation and reassembly, and moves operations normally performed by an application and performs them in devices on a card. For example, using system 100 a testing system and operation can be performed on a card outside of processor 102. This substantially reduces overhead on processor 102, making its operation more efficient.

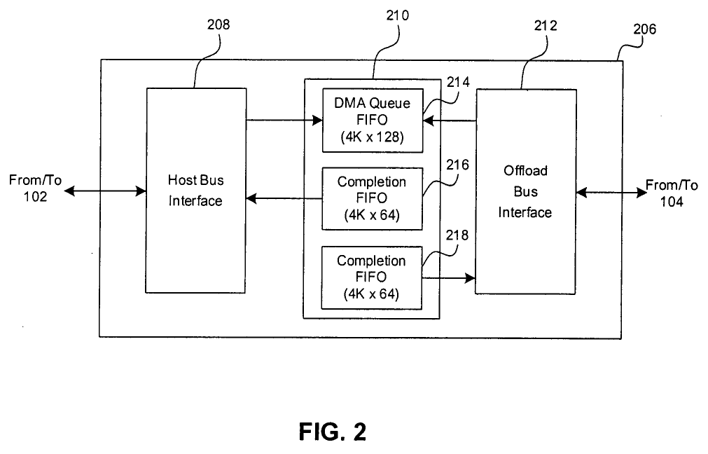

FIG. 2 shows an exemplary interface system 206, according to one embodiment of the present invention. Interface system 206 comprises a first bus interface 208 (e.g., a PCI bus interface), which is associated with first processor 102, a memory system 210, and a second bus interface 212 (e.g., a HT bus interface), which is associated with second processor 104. Memory system 210 includes a first queue 214 (e.g., a DMA queue) associated with both bus interfaces 208 and 212 and both processors 102 and 104, a second queue 216 (e.g., a completion queue) associated with first bus interface 208 and first processor 102, and a third queue 218 (e.g., a completion queue) associated with second bus interface 212 and second processor 104.

In one example, interface system 206 operates at very close to limits of PCI bus interface 208. It supports 64-bit 66 MHz PCI, and can achieve roughly 500 MBytes/s of throughput out of a maximum of 528 MBytes/s. In this example PCI bus interface 208 is half duplex and the HT bus interface 212 is full duplex, which operates at 800 MBytes/s in both directions.

Example sizes of queues 214, 216, and 218 are shown in FIG. 2. It is to be appreciated that other sizes of these queues are also contemplated within the scope of the present invention. For example, anywhere from 5 to 4000 segment storage areas can exist in each of queues 214, 216, and/or 218. Also, in one example queues 214, 216, and 218 are first-in-first-out (FIFO) memory devices.

In one example, queues 214, 216, and 218 are designed as “deep” queues, which allow continuous streaming of information without reaching capacity. This allows interface system 206 to write data into a write cache and for processors 102 and/or 104 to run without being interrupted because there is no reading of incoming information, which speeds up transfer of information between processors 102 and 104 and increases system throughput.

Thus, interface system 206 has on-chip memory for command (e.g., DMA) and done (e.g., Completion) queues 214, 216, and 218, respectively. There is space on-chip for thousands of commands and completion entries. This allows each side of system 100 to freely write commands into interface system 206 without concern for overflow. The chip synchronizes between the two “writers” into command queue 214, and each done queue 216 and 218 only feeds one processor 102 or 104, respectively.

In one example, DMA Queue 214 is the Command Queue, and it is 4K entries long. Both processors 102 and 104 add entries into command queue 214. This is done either through a “long interface system,” which takes three “stores” to interface system 206, and thus requires interlocks between threads/multiple processes, or through a “Quick DMA interface system,” which takes a single 64-bit store. When a command completes (e.g., the transfer it requests has been completed), the command is removed from Command Queue 214. It may be discarded or posted to one of Done Queues 216 and/or 218 as determined by flags in the original command.

In one example, the “Quick DMA” interface system facilitates multiprocessing especially in an SMP (Symmetric Multi-Processor) system. There is no need to set any interlocks using the Quick DMA. That is, each process/processor 102 and 104 that is using the interface system can set up a Quick DMA “word” and store it to interface system 206. A respective one of bus interfaces 208 and 212 will insure that one processor 102 or 104 at a time gets access to a respective bus interface 208 or 212, and each Quick DMA request will be queued as it is received.

In one example, when command queue 214 reaches capacity or a predetermined threshold level, there is a high-water interrupt, which can be programmable, that will interrupt one or both sides (e.g., one or both processors 102 or 104) to warn them that queue 214 is reaching capacity. In one example, the high-water interrupt can be used to slow or stop processor operations until a time when a low-water threshold is met. For example, the low-water threshold can be half the high-water threshold. The high-water threshold can be set to allow queue 214 to release stored information (e.g., drain). This is done by slowing down one or both processors 102 or 104 until a low-water threshold is met. In this example, when the low-water threshold is met, processors 102 and/or 104 can continue normal operations by clearing any flag associated with a high-water threshold met condition.

Basically, using this scheme, queue 214 is long enough and interface system 206 is fast enough that queue 214 never gets very deep, allowing both sides to run as fast as they can without having to test for queue availability. As compared to conventional systems, this is much more efficient than having to test some variable or register to see if a queue is full before every new entry is added.

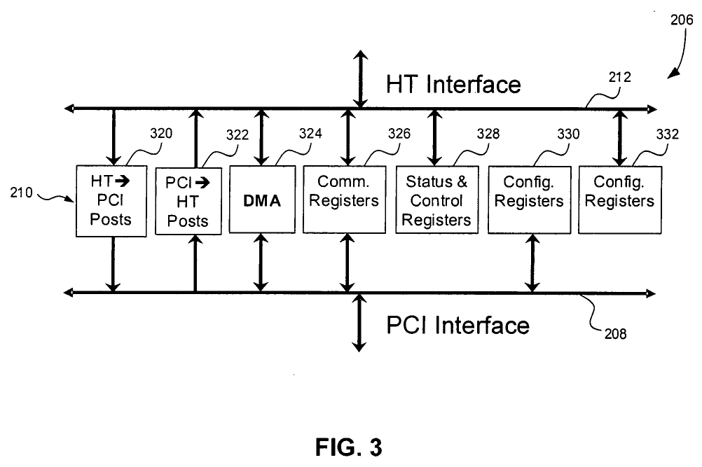

FIG. 3 shows details of interface system 206, according to one embodiment of the present invention. In this embodiment, memory system 210 includes a HT to PCI Posts device 320, a PCI to HT Posts device 322, a DMA controller 324, a commands register 326 for both bus interfaces 208 and 212, status and control registers 328 for bus interface 212, and configuration registers 330 and 332 for bus interfaces 208 and 212, respectively.

Exemplary Storing Operation of the Interface System

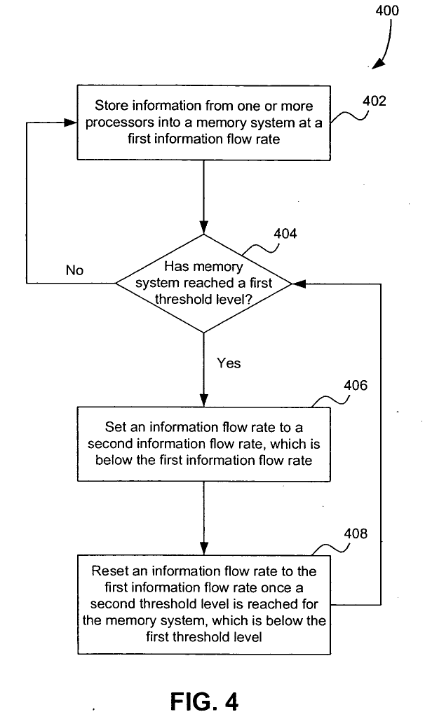

FIG. 4 is a flow chart depicting a storing method 400, according to one embodiment of the present invention. In one example, system 100, as depicted in FIGS. 1, 2, and/or 3, performs method 400. In step 402, information is stored from processors 102 and 104 into memory system 210 at a first information flow rate. In step 404, a determination is made whether the memory system has reached a first threshold level (e.g., a high-water threshold level). If no, method 400 returns to step 402. If yes, in step 406 an information flow rate is set to a second information flow rate, which is below the first information flow rate. In step 408, once a second threshold level (e.g., a low-water threshold) is reached for the memory system, which is below the first threshold level, the information flow rate is again set to the first information flow rate. This ensures that command queue 214 does not reach its capacity, as described above.

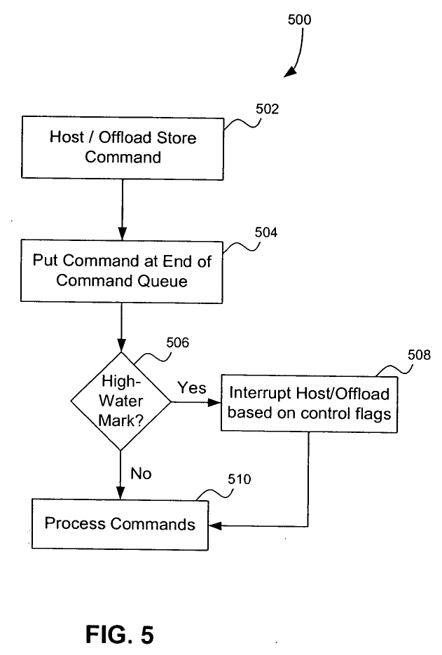

FIGS. 5, 6, 7, and 8 are flow charts depicting portions of a storage method 500, according to one embodiment of the present invention. In one example, system 100, as depicted in FIGS. 1, 2, and/or 3, performs method 500.

Referring to FIG. 5, in step 502, either first or second processor 102 or 104 stores information (e.g., a command) in command queue 214. In step 504, interface system 206 puts the command at an end of queue 214. This will most typically be implemented as a circular ring in a memory. In step 506, interface system 206 checks to see if a high-water mark (e.g., the first threshold) for command queue 214 has been reached.

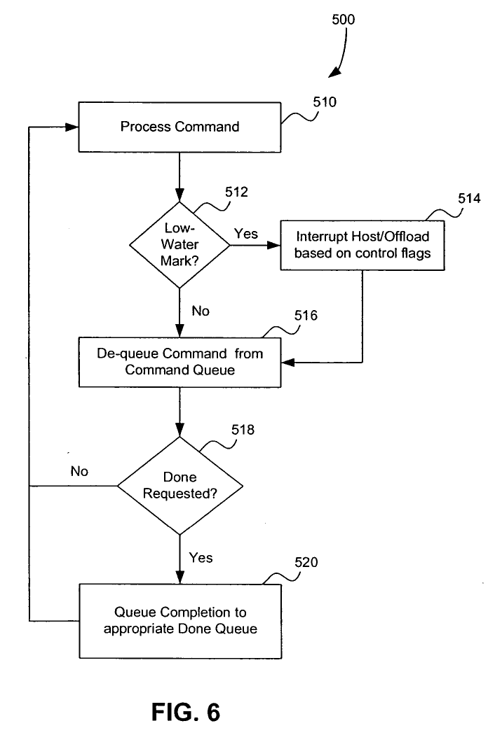

If a high-water mark is reached, then commands are being stored faster than they can be processed. In this case, in step 130 host 102 and/or offload processors 104 are interrupted to let them know that the high-water mark on command queue 214 has been reached. Typically, host processor 102 and/or indicates via another interrupt (discussed in more detail with relation to FIG. 6) that command queue 214 has drained sufficiently to resume command queuing. It is to be appreciated that, in this embodiment, the high-water mark is not “full.” There are many slots still available so that any command stores already in process can complete without overflowing command queue 214. In step 510, interface system 206 goes on to process commands.

With reference to FIG. 6, after step 510, in step 512 interface system 206 checks if a low-water mark (e.g., the second threshold level) has been reached. This will only be true if the high-water mark has been reached and host processor 102 and/or offload processor 104 are waiting for command queue 214 to drain.

If yes, in step 514 host processor 102 and/or offload processor 104 are interrupted and in step 516 the command is removed from command queue 214. If no, method 500 moves to step 516.

In step 518, a determination is made whether a done notification is requested in the command's flags. If yes, in step 520 a done is queued to the requested done queue and method 500 returns to step 510. If no, method 500 returns to step 510.

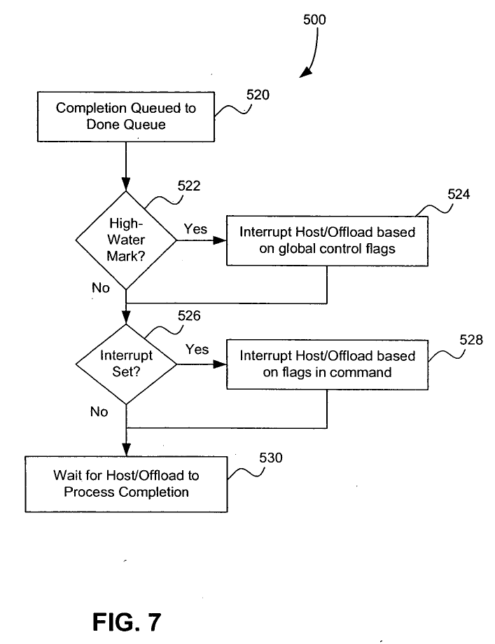

With reference to FIG. 7, in one example, after step 520 is performed, in step 522 a determination is made whether the high-water mark has been reached.

If yes, then completions are occurring faster than host processor 102 and/or offload processor 104 can process them, such that in step 524 an interrupt is generated if set in global control flags. This will either force host processor 102 and/or offload processor 104 to de-queue completions from done queues 216 and/or 218, respectively, or it will trigger a fatal error condition. After this, method 500 moves to step 526.

However, if the answer to step 522 is no, then method 500 moves to step 526.

In step 526, interface system 206 checks to see if the completion has an interrupt request. If yes, host processor 102 and/or offload processor 104 will be interrupted. The, method 500 moves to step 530. If no, method 500 moves to step 530. In step 530, interface system 206 goes back to its main processing loop.

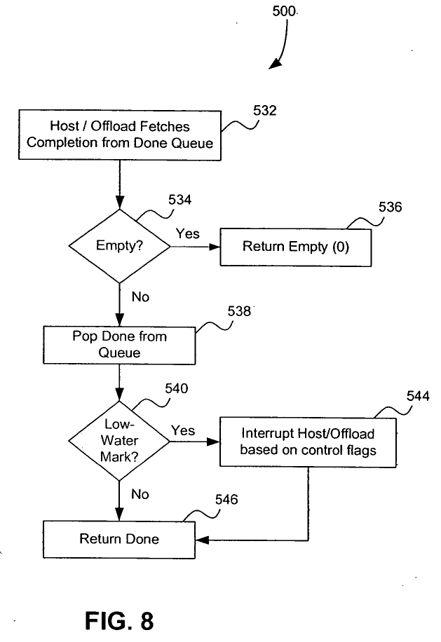

Referring to FIG. 8, after step 530 method 500 moves to step 532. In step 532, host processor 102 and/or offload processor 104 reads from its Done Queue 216 and/or 218. In step 534, a determination is made whether the queue is empty. If yes, in step 536 an Empty result is returned. Otherwise, in step 538 a completion is popped from queue 216 and/or 218 and a check is made for Low-Water Mark. In step 540, a determination is made whether a Low-Water Interrupt is set. If yes, in step 544 host processor 102 and/or offload processor 104 will be interrupted. Then, method 500 moves to step 546. If no, method 500 moves to step 546. In step 546, the completion will be returned.

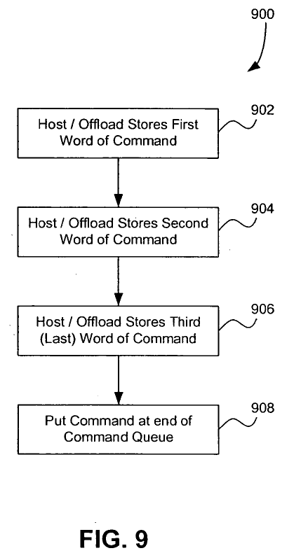

FIG. 9 is a flow chart depicting an information storage method, according to one embodiment of the present invention. In this embodiment, a normal form of a command takes three 64-bit words. In step 902, a first word is stored to interface system 206, then in step 504 a second word is stored, and finally in step 906 a third word is stored. Storing the third word triggers interface system 206 to push the command onto command queue 214.

In an example in a SMP environment, access to the three command registers must be protected by a lock in software between the multiple processors or threads.

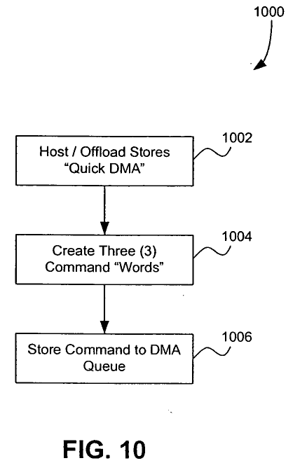

FIG. 10 is a flow chart depicting an information storage method, according to one embodiment of the present invention. In step 1002, host processor 102 and/or offload processor 104 stores a short form or “Quick DMA” as a single 64-bit word to interface system 206. In step 1004, this word is combined with preset address registers to create the three words required of a normal command, as discussed in relation to FIG. 9 above. In step 1006, the result is stored on command queue 214. In one example, for small memory environments or for message passing (described below), Quick DMA is fast and efficient because only random large memory moves require full commands.

Message Passing Interface Portion of the Interface

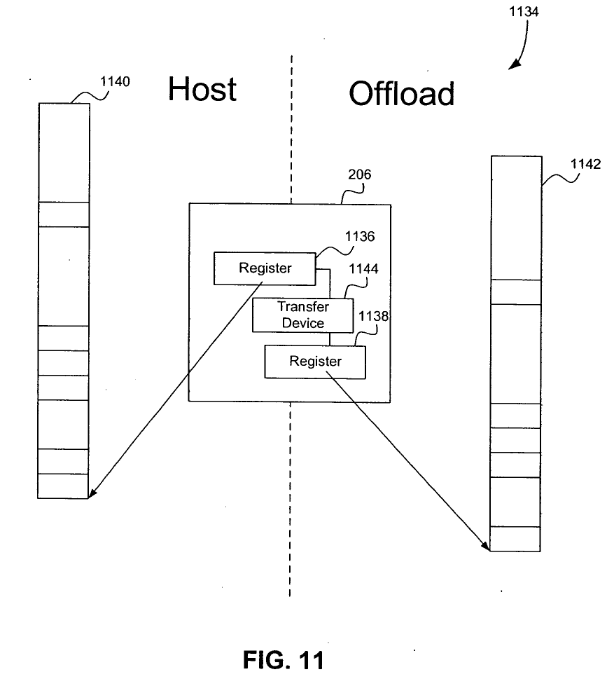

FIG. 11 shows a portion 1134 of system 100, according to one embodiment of the present invention. Portion 1134 comprises registers 1136 and 1138 and related tables 1140 and 1142 associated with respective processors (not shown). In this embodiment, interface system 206 implements a unique message passing interface. Each side sets up a table 1140 and 1142, respectively, of “message blocks.” In one example, tables 1140 and 1142 are the same size. In this embodiment, each block is a multiple of 32 bytes. These tables 1140 and 1142 are mirrored on both sides. For example, a block in one table 1140 is copied to a same block in table 1142 on the other side. This copying is done via transfer device 1144 under control of processor 102 or 104, whichever one “owns” the block. Block ownership changes back and forth between processors 102 and 104. At initialization, tables 1140 and 1142 are set up identically, with all owned by one side. That side “passes” some of the blocks to the other side, by setting ownership to the other side and “sending” them across. Then, the other side is alerted a message was passed. This alerting can be done after a command has completed and moved from command queue 214 to one of done queues 216 or 218. This allows a done queue 216 or 218 receiving a command to know, via registers 1136 or 1138, where a message table 1140 or 1142 and related message is for the received command.

Each side sets a register 1136 or 1138 in interface system 206 that points to the base of its respective Message table 1140 or 1142. This is done once at initialization, however it may also be done at any time if the message table needs to be moved, such as to increase its size.

The processor that owns a block can fill it in at will. The hardware knows nothing about the contents of a block. When it is time to send the information in the block to the other side, a “Quick DMA” is written to interface system 206 that specifies an offset in a message table 1140 or 1142, a length (in 8-byte chunks), and some flags, such as which direction to move the “message,” “interrupt the other side”, etc. An example information block is:

| 63 48 | 47 40 | 39 32 | 31 0 |
|---|---|---|---|
| Length | Info | Flags | Offset |

This queues a command onto interface system 206 deep command queue 214. When the command is processed, the message block is transmitted across interface system 206, a done indicator is queued to the destination processor 102 or 104 (if chosen in the flags) via done queues 216 or 218, and an interrupt is generated (if chosen in the flags). For multiple blocks, only the last one need have an interrupt flag set.

The done queue 216 or 218 on each side contains a FIFO of one word completion status indicators that point to the block that was transferred and contains flags (“Info” in the description) passed by the sender. An example information block is:

| 63 48 | 47 40 | 39 0 |
|---|---|---|
| Checksum | Info | Address |

Thus, when the receiver gets an interrupt, it begins reading a respective done queue 216 or 218, which is a fixed address in interface system 206. For each non-zero result, one transfer has been completed, and the done status points to the completed transfer. There is a byte of uninterrupted bits (Info) that tells the receiver what type of transfer this was (e.g., a message, data, a command, etc.).

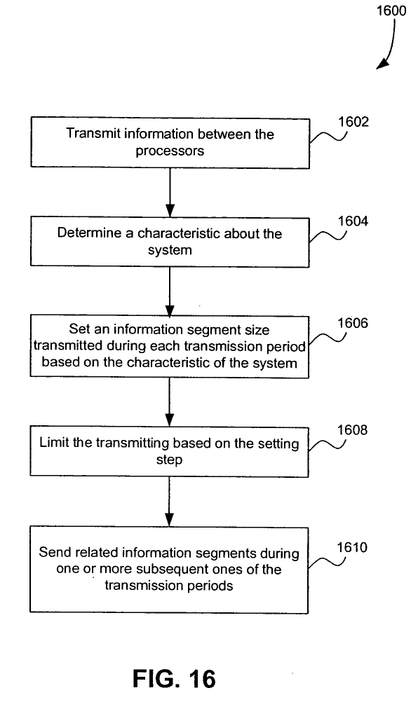

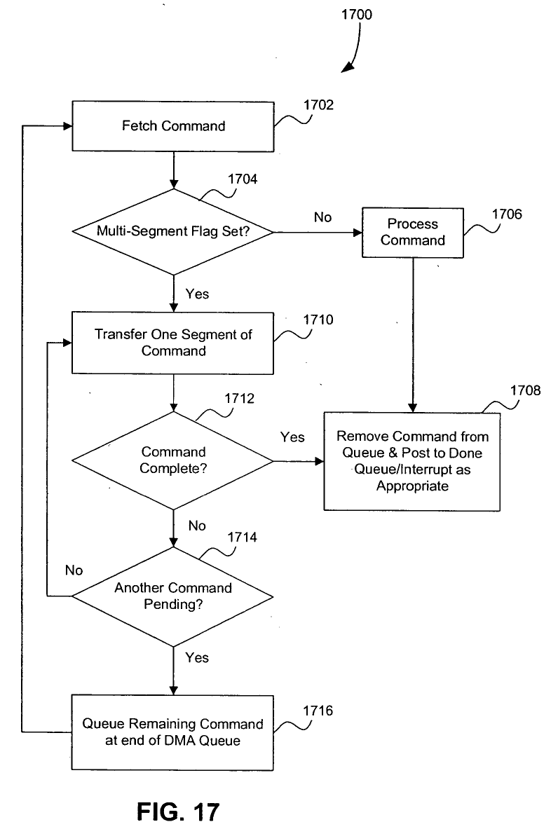

Transfer completions may be discarded or posted to one of done queues 216 or 218. For example, when moving a data segment (e.g., as discussed in more detail below with reference to FIGS. 16 and 17) as opposed to a message, the sender wants to know when the transfer is complete so it can free the buffer. In contrast, when sending a message, the receiver needs to get the done and the sender doesn't care. Interrupts follow the done queue. There may be none, or an interrupt may be generated on the side that receives a done posting. Interrupts may only be necessary on the last command of a series, for example, data, data, data, message +interrupt. In this example, the sender of the data segments needs to know when they complete to free up the space, while the receiver of the message will get the data addresses from the message and have everything necessary to process that request.

Exemplary Message Passing Operation

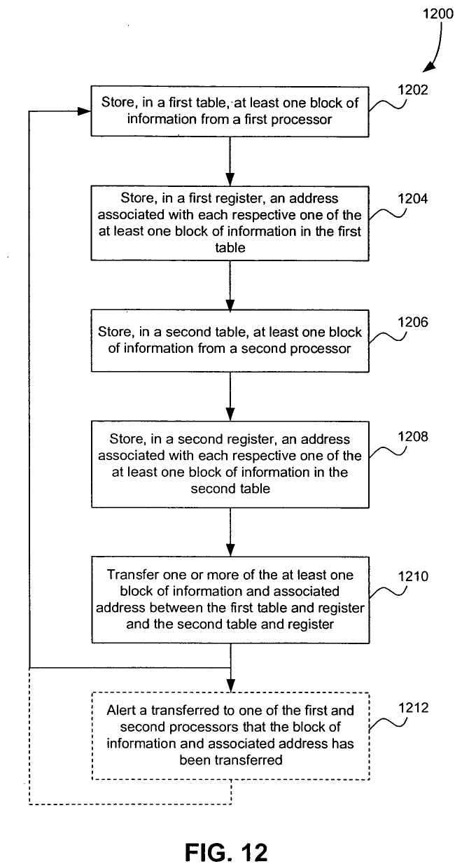

FIG. 12 is a flowchart depicting a message passing method 1200, according to one embodiment of the present invention. In one example, system 100 implements method 1200 using elements described above with reference to FIGS. 1-3 and 11. In step 1202, at least one block of information from processor 102 is stored in first table 1140. In step 1204, an address associated with each respective one of the at least one block of information stored in first table 1140 is stored in register 1136. In step 1206, at least one block of information from processor 104 is stored in second table 1142. In step 1208, an address associated with each respective one of the at least one block of information stored in second table 1142 is stored in register 1138. In step 1210, one or more of the at least one block of information and associated address is transferred between first table 1140 and first register 1136 and second table 1142 and second register 1138. In an optional step 1212, a transferred to one of processors 102 or 104 is alerted that the block of information and associated address has been transferred.

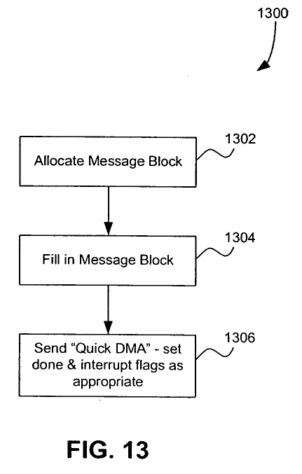

FIG. 13 is flow chart depicting a message passing method 1300, according to one embodiment of the present invention. In one example, system 100 implements method 1300 using elements described above with reference to FIGS. 1-3 and 11. In one example, a message is exchanged quickly and with low-overhead. In step 1302, a message block is allocated. It is be appreciated that free blocks are typically kept on linked-list queue. In step 1304, the message block is filled in. In step 1306, the message is “sent” to the other processor, for example using Quick DMA as described above. The whole operation takes 10 cycles of instructions and the only lock required is in the message allocation de-queuing code. For a very short message, all of the message data fits within the message block itself, so these few steps are a complete transaction.

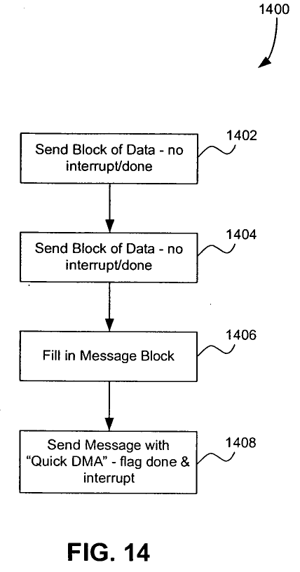

FIG. 14 is flow chart depicting a message passing method 1400, according to one embodiment of the present invention. In one example, system 100 implements method 1400 using elements described above with reference to FIGS. 1-3 and 11. In steps 1402 and 1404, blocks of information are sent with regular commands. These blocks of information or segments (e.g., chunks) of information, which may be a relatively longer message than information in FIG. 13, are sent to a receiving one of the processors 102 or 104, which also needs to be told about that data. In steps 1406 and 1408, a Quick DMA is used to tell the receiving processor 102 or 104 about the data.

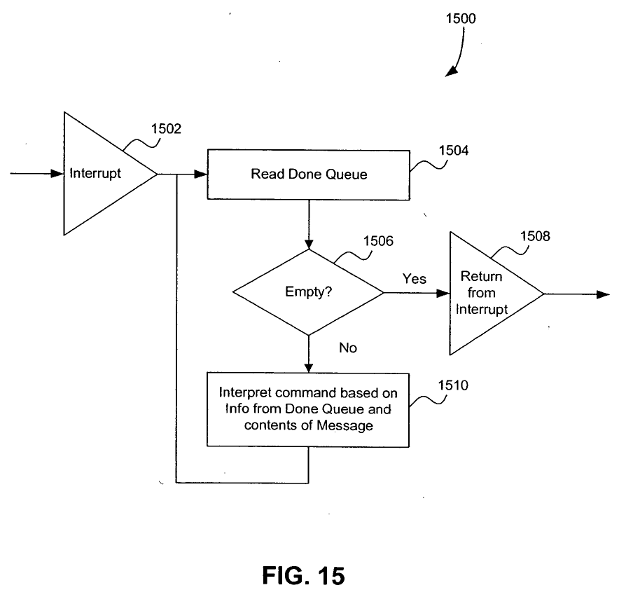

FIG. 15 is flow chart depicting a method 1500, according to one embodiment of the present invention. In one example, system 100 implements method 1500 using elements described above with reference to FIGS. 1-3 and 11. Method 1500 relates to when a message is received on one side. In step 1502, an interrupt will trigger an interrupt routine. In step 1504, the interrupt routine will read a respective Done Queue 216 or 218. In step 1506, a determination is made whether the Done queue 216 or 218 is Empty. If yes, in step 1508 processing is complete and a return from interrupt can be executed. If no (e.g., there is a completion pending), in step 1510 the command can be interpreted based on the Info bits from Done Queue 216 or 218, and the contents of the message block, pointed to by the Done Queue entry. In step 1512, after processing one command, method 1500 loops back to step 1504 until there are no more entries.

Although interface system 206 does not perform any particular memory management scheme, in one example a collection of memory buffers are set aside in each processor 102 or 104 and then “passed” to the other side for its use. Each processor 102 or 104 “owns” a collection of buffers that it can write to in the other processors memory. Once such a buffer has been filled, a message is sent to the other processor 102 or 104 telling it what the buffer is for. Once the receiving processor 102 or 104 has processed the data, it can “pass” the buffers back to the other side with a message. If one side needs buffers to store into on the other side (i.e., processor 102 or 104 has run out of allocated buffers), processor 102 or 104 can send a request message to ask the other side for more. The receiving side of such a request can ignore the request, which allows buffers to free up as they are processed or the receiving side can allocate more memory and pass the new buffers to the other side. It is also possible for excess buffers to be freed in this fashion when traffic is light and the pool of buffers is large, then they can be de-allocated with a message. Deallocation of memory is always harder than allocation, thus in one example hysteresis is used to prevent system 100 from oscillating on memory allocation and deallocation.

Exemplary Tunable Bulk Transfer Priority Operation

Once information (e.g., a command) is in queue 214, it will get executed when it reaches a head of the queue 214. However, when the command is a “long” transfer, longer than a programmable parameter, then the command will be processed in “chunks” or “segments,” so long as the message's flags allow for this segmentation. For example, this may be data (e.g., audio, video, etc.) that is about 1 MByte or more. In this example, after each segment of a long transfer command is completed by queue 214, the other segments are moved to an end of queue 214 to be subsequently completed. Thus, to move a very large command across interface system 206, one segment will be moved, then the command will be re-queued at the end of queue 214. This will continue until the whole transfer has completed.

In one example, if there are no commands behind a long transfer (i.e., nothing else pending), then the transfer will continue until it completes or another command is queued.

In another example, if a smaller commands is behind the long command, a segment of the long command is sent, the other segments are moved behind the short command, which is send next, then the remaining segments of the long command are sent.

In one example, a segment size is set, programmed, or tuned to balance latency with bandwidth (i.e., long enough to get desired bus efficiency, while short enough to low latency). It is to be appreciated that the segment size is both bus and application specific. For example, if the segment size is large (e.g., 64K), then commands that are pending will be delayed by the time it takes to move a 64K chunk (e.g., 130 microseconds), but bus interface efficiency will be very high because a respective bus interface 208 or 212 will be transferring very large blocks. As the segment size goes below 8K, the latency improves, but bus interface efficiency starts to drop. In one example, any segment size above 1K will be reasonably efficient with low latency (e.g., a couple of microseconds).

Thus, as compared to conventional priority schemes, the above described priority scheme is better than a multiple queue interface system because no queue can get blocked out. Once a large transfer gets started in conventional schemes, it must complete before other commands in that queue get processed. However, according to the embodiment and examples of the present invention described above and below, all commands get processed in a timely fashion. Conventional multiple queue schemes need rules and logic for prioritizing and managing the multiple queues. However, according to the embodiment and examples of the present invention described above and below, they are a very simple way to implement a dual priority scheme with a single queue while maintaining fairness and allowing for forward progress on all commands.

FIG. 16 is a flowchart depicting a method 1600, according to one embodiment of the present invention. In one example, system 100 implements method 1600 using elements described above with reference to FIGS. 1-3 and 11. Method 1600 relates to the priority scheme discussed above. In step 1602, information is transmitted between processors 102 and 104. In step 1604, a characteristic about system 100 is determined. For example, a maximum transfer rate of a respective bus, a burst length transfer limit, latency threshold, or the like, can be used as the characteristic. It is to be appreciated that other characteristics would be apparent to one of ordinary skill in the art upon reading this description, which are all contemplated within the scope of the present invention. In step 1606, an information segment size that can be transmitted during each transmission period is set based on the characteristic of system 100. In step 1608, a size of transmitted information is limited during transmission based on the set information segment size. In step 1610, related ones of the information segments are sent during one or more subsequent ones of the transmission periods.

FIG. 17 is a flowchart depicting a method 1700, according to one embodiment of the present invention. In one example, system 100 implements method 1700 using elements described above with reference to FIGS. 1-3 and 11. Method 1700 relates to the priority scheme discussed above. In step 1702, a command is fetched. In step 1704, a determination is made whether the command's Multi-Segment flag is checked. If it is not set, in step 1706 the command is processed and in step 1708 the command is removed from queue 214 and posted to a respective done queue 216 or 218. Optionally, an interrupt is generated if necessary. If Multi-Segment is set, in step 1710 a first “Segment” of the command is processed (e.g., transferred). In one example, a length of a Segment is programmed in a register (not shown in FIG. 17, for example register 326 in FIG. 3) in interface system 206. In step 1712, after completing one Segment a determination is made whether the command is complete (i.e., was this the last segment). If yes, step 1708 is performed. If no, in step 1714 a determination is made whether another command is pending. If there are no other commands pending, method 1700 returns to step 1710 and another segment of the command is processed and the process repeats. If there is another command pending, in step 1716 the present command is removed from the head of command queue 214 and the remainder of the present command is pushed on the tail of command queue 214. After step 1716, method 1700 returns to step 1702.

In one example, there can be many “long” commands in queue 214, and they will all make equal progress towards completion while allowing short commands to be interleaved with long transfers.

It is to be appreciated that a segment length could also be programmed with each command rather than being a global value. For example, this would give even more fine-grained control, but at the expense of more memory for the command queue.

Exemplary Computer System

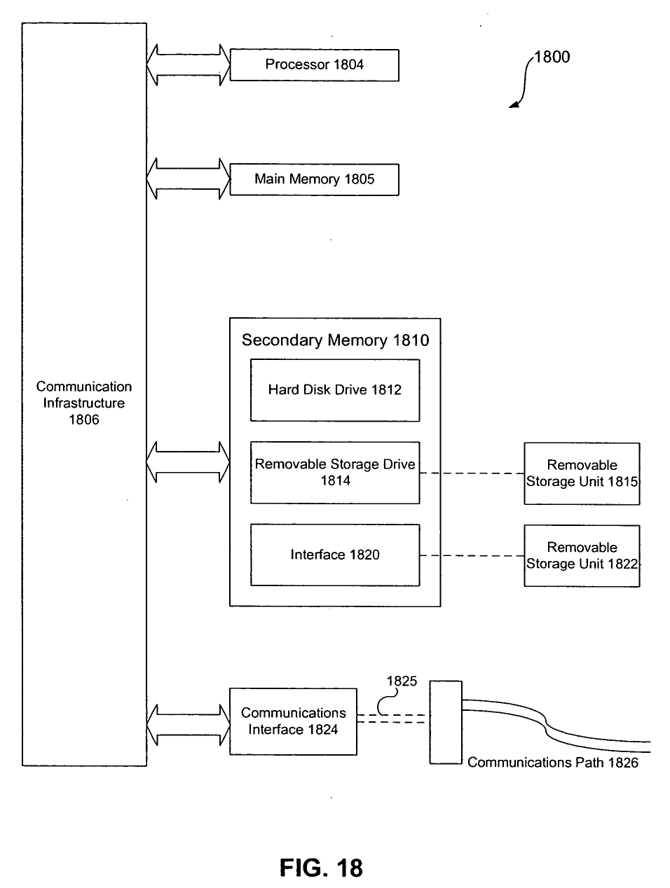

FIG. 18 illustrates an example computer system 1800, in which the present invention can be implemented as computer-readable code. Various embodiments of the invention are described in terms of this example computer system 1800. After reading this description, it will become apparent to a person skilled in the relevant art how to implement the invention using other computer systems and/or computer architectures.

The computer system 1800 includes one or more processors, such as processor 1804. Processor 1804 can be a special purpose or a general purpose digital signal processor. The processor 1804 is connected to a communication infrastructure 1806 (for example, a bus or network). Various software implementations are described in terms of this exemplary computer system. After reading this description, it will become apparent to a person skilled in the relevant art how to implement the invention using other computer systems and/or computer architectures.

Computer system 1800 also includes a main memory 1808, preferably random access memory (RAM), and may also include a secondary memory 1810. The secondary memory 1810 may include, for example, a hard disk drive 1812 and/or a removable storage drive 1814, representing a floppy disk drive, a magnetic tape drive, an optical disk drive, etc. The removable storage drive 1814 reads from and/or writes to a removable storage unit 1818 in a well known manner. Removable storage unit 1818, represents a floppy disk, magnetic tape, optical disk, etc. which is read by and written to by removable storage drive 1814. As will be appreciated, the removable storage unit 1818 includes a computer usable storage medium having stored therein computer software and/or data.

In alternative implementations, secondary memory 1810 may include other similar means for allowing computer programs or other instructions to be loaded into computer system 1800. Such means may include, for example, a removable storage unit 1822 and an interface 1820. Examples of such means may include a program cartridge and cartridge interface (such as that found in video game devices), a removable memory chip (such as an EPROM, or PROM) and associated socket, and other removable storage units 1822 and interfaces 1820 which allow software and data to be transferred from the removable storage unit 1822 to computer system 1800.

Computer system 1800 may also include a communications interface 1824. Communications interface 1824 allows software and data to be transferred between computer system 1800 and external devices. Examples of communications interface 1824 may include a modem, a network interface (such as an Ethernet card), a communications port, a PCMCIA slot and card, etc. Software and data transferred via communications interface 1824 are in the form of signals 1828 which may be electronic, electromagnetic, optical or other signals capable of being received by communications interface 1824. These signals 1828 are provided to communications interface 1824 via a communications path 1826. Communications path 1826 carries signals 1828 and may be implemented using wire or cable, fiber optics, a phone line, a cellular phone link, an radio frequency (RF) link and other communications channels.

In this document, the terms “computer program medium” and “computer usable medium” are used to generally refer to media such as removable storage drive 1814, a hard disk installed in hard disk drive 1812, and signals 1828. Computer program medium and computer usable medium can also refer to memories, such as main memory 1808 and secondary memory 1810, that can be memory semiconductors (e.g. a dynamic random access memory (DRAM), etc.) These computer program products are means for providing software to computer system 1800.

Computer programs (also called computer control logic) are stored in main memory 1808 and/or secondary memory 1810. Computer programs may also be received via communications interface 1824. Such computer programs, when executed, enable the computer system 1800 to implement the present invention as discussed herein. In particular, the computer programs, when executed, enable the processor 1804 to implement the processes of the present invention, such as operations in one or more elements in system 100, as depicted by FIGS. 1-3 and 11, and operations discussed as exemplary operations of system 100 above. Accordingly, such computer programs represent controlling systems of the computer system 1800. Where the invention is implemented using software, the software may be stored in a computer program product and loaded into computer system 1800 using removable storage drive 1814, hard drive 1812 or communications interface 1824.

The invention is also directed to computer products (also called computer program products) comprising software stored on any computer useable medium. Such software, when executed in one or more data processing device, causes the data processing device(s) to operation as described herein. Embodiments of the invention employ any computer useable or readable medium, known now or in the future. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, optical storage devices, MEMS, nanotechnological storage device, etc.), and communication mediums (e.g., wired and wireless communications networks, local area networks, wide area networks, intranets, etc.). It is to be appreciated that the embodiments described herein can be implemented using software, hardware, firmware, or combinations thereof.

Other Embodiments

The embodiments described above are provided for purposes of illustration. These embodiments are not intended to limit the invention. Alternate embodiments, differing slightly or substantially from those described herein, will be apparent to persons skilled in the relevant art(s) based on the teachings contained herein. Such alternate embodiments fall within the scope and spirit of the present invention.

Conclusion

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

1. A system, comprising:
a first portion having at least a first processor;
a second portion having at least a second processor; and
an interface system coupled between the first processor and the second processor, the interface system including a memory system, wherein the interface system allows for writing of information from one or both of the first and second processors to the memory system without a read operation.

2. The system of claim 1, wherein the interface system further comprises:
a first bus interface associated with the first processor; and
a second bus interface associated with the second processor.

3. The system of claim 2, wherein the memory system comprises:
a first queue coupled to the first and second bus interfaces,
a second queue coupled to the first bus interface, and
a third queue coupled to the second bus interface.

4. The system of claim 3, wherein:
the first queue is a command queue; and
the second and third queues are completion queues.

5. The system of claim 3, wherein:
the first, second, and third queues each allow for up to approximately 4000 entries to be stored.

6. The system of claim 2, wherein information flow rates of the first and second bus interfaces are different.

7. The system of claim 1, wherein the writing is performed without requiring spin locking of either the first or second processors.

8. The system of claim 1, wherein the interface system further comprises:
a means for determining if the memory system is at a threshold value at a present information flow rate; and
a means for setting an information writing rate to predetermined value, which is lower than the present information flow rate, if the means for determining determines the memory system is at the threshold value.

9. The system of claim 1, wherein the interface system further comprises:
a first table associated with the first processor, the first table storing one or more blocks of the information;
a first register associated with the first table that registers addresses of the one or more blocks of the information in the first table;
a second table associated with the second processor, the second table storing one or more blocks of the information;
a second register associated with the second table that registers addresses of the one or more blocks of the information in the second table; and
a transfer device that moves one or more of the one or more blocks of the information and corresponding ones of the addresses between the first table and register and the second table and register.

10. The system of claim 9, wherein the blocks of the information comprise messages or commands.

11. The system of claim 1, wherein the interface system further comprises:
a means for setting a maximum information size of the information to be sent during each transmitting period, wherein segments of the information above the maximum information size are sent during one or more subsequent transmitting periods.

12. The system of claim 11, wherein the means for setting comprises:
a means for determining characteristics about a bus interface associated with at least one of the first and second processors, wherein the means for setting uses the characteristics to set the maximum information size.

13. The system of claim 12, wherein the characteristics comprise at least a maximum information flow rate of the bus interface.

14. The system of claim 11, wherein the means for setting comprises:
a means for determining a maximum latency desired, wherein the means for setting uses the maximum latency to set the maximum information size.

15. The system of claim 11, wherein the information is data.

16. An interface system in a system including at least a first portion having at least a first and a second computer having at least a second portion, comprising:
a first bus interface associated with the first processor;
a second bus interface associated with the second processor; and
a memory system,
wherein the interface system allows for writing of information from one or both of the first and second processors to the memory system without a read operation.

17. The interface system of claim 16, wherein the memory system comprises:
a first queue coupled to the first and second bus interfaces,
a second queue coupled to the first bus interface, and
a third queue coupled to the second bus interface.

18. The interface system of claim 17, wherein:
the first queue is a command queue; and
the second and third queues are completion queues.

19. The interface system of claim 17, wherein:
the first, second, and third queues each allow for up to approximately 4000 words to be stored.

20. The interface system of claim 18, wherein information flow rates of the first and second bus interfaces are different.

21. The interface system of claim 16, wherein the writing is performed without requiring spin locking of either the first or second processors.

22. The interface system of claim 16, further comprising:
a means for determining if the memory system is at a threshold value at a present information flow rate; and
a means for setting an information writing rate to predetermined value, which is lower than the present information flow rate, if the means for determining determines the memory system is at the threshold value.

23. The interface system of claim 16, further comprising:
a first table associated with the first processor, the first table storing one or more blocks of the information;
a first register associated with the first table that registers addresses of the one or more blocks of the information in the first table;
a second table associated with the second processor, the second table storing one or more blocks of the information;
a second register associated with the second table that registers addresses of the one or more blocks of the information in the second table; and
a transfer device that moves one or more of the one or more blocks of the information and corresponding ones of the addresses between the first table and register and the second table and register.

24. The interface system of claim 23, wherein the blocks of the information comprise messages or commands.

25. The interface system of claim 16, further comprising:
a means for setting a maximum information size of the information to be sent during each transmitting period, wherein segments of the information above the maximum information size are sent during one or more subsequent transmitting periods.

26. The interface system of claim 25, wherein the means for setting comprises:
a means for determining characteristics about at least one of the first and second bus interfaces, wherein the means for setting uses the characteristics to set the maximum information size.

27. The interface system of claim 26, wherein the characteristics comprise at least a maximum information flow rate of at least one of the bus interfaces.

28. The interface system of claim 25, wherein the means for setting comprises:
a means for determining a maximum latency desired, wherein the means for setting uses the maximum latency to set the maximum information size.

29. A method, comprising:
(a) storing information from one or more processors into a memory system at a first information flow rate;
(b) determining if the memory system has reached a first threshold level;
(c1) if yes in step (b), setting changing the first information flow rate to a second information flow rate, which is below the first information flow rate;
(c2) if no in step (b), continue performing steps (a) and (b); and
(d) if (c1) is performed, resetting an information flow rate to the first information flow rate once a second threshold level is reached for the memory system, which is below the first threshold level.

30. A method, comprising:
(a) storing, in a first table, at least one block of information from a first processor;
(b) storing, in a first register, an address associated with each respective one of the at least one block of information in the first table;
(c) storing, in a second table, at least one block of information from a second processor;
(d) storing, in a second register, an address associated with each respective one of the at least one block of information in the second table;
(e) transferring one or more of the at least one block of information and associated address between the first table and first register and the second table and second register.

31. The method of claim 30, further comprising:
(f) alerting a transferred to one of the first and second processors that the block of information and associated address has been transferred.

32. A method, comprising:
(a) transmitting information between processors in a system having at least two processors;
(b) determining a characteristic about the system;
(c) setting an information segment size transmitted during each transmission period based on the characteristic of the system;
(d) limiting step (a) based on step (c); and
(e) sending related ones of the information segments during one or more subsequent ones of the transmission periods.

33. The method of claim 32, wherein step (c) comprises:
determining a maximum information segment size of one or all of respective bus interfaces associated with the at least two processors; and
using the maximum information segment size to set the transmitted information segment size.

34. The method of claim 32, wherein step (c) comprises:
determining a latency threshold level of the system; and
using the latency threshold to set the transmitted information segment size.

35. The system of claim 1, wherein the interface system comprises a field programmable gate array (FPGA).

36. The interface system of claim 16, wherein the first and second bus interfaces and the memory device are included in a FPGA.
